(19) United States
(12) Patent Application Publication
(10) Pub. No.: US 2013/0070066 A1
(43) Pub. Date: Mar. 21, 2013

(54) THREE-DIMENSIONAL DISPLAY APPARATUS AND DATA PROCESSING METHOD THEREOF

(71) Applicants: Tao-Ching Yu, Taoyuan County (TW); Jhen-Shen Liao, Taoyuan County (TW); Hung-Hsiang Chen, Taoyuan County (TW)

(72) Inventors: Tao-Ching Yu, Taoyuan County (TW); Jhen-Shen Liao, Taoyuan County (TW); Hung-Hsiang Chen, Taoyuan County (TW)

(73) Assignee: CHUNGHWA PICTURE TUBES, LTD., Taoyuan (TW)

(21) Appl. No.: 13/295,100

(22) Filed: Nov. 14, 2011

(30) Foreign Application Priority Data
Sep. 16, 2011 (TW) 100133471

(51) Int. Cl. H04N 13/04; H04N 13/00

(52) U.S. Cl. 348/54; 348/42

(57) ABSTRACT

A three-dimensional display apparatus and a data processing method thereof are provided. The three-dimensional display apparatus includes a data processing module. The data processing module includes an image comparison unit and an image compensation unit. The image comparison unit receives a first eye frame and a second eye frame in order, compares a plurality of first gray-scale data of the first eye frame with a plurality of second gray-scale data of the second eye frame respectively, and outputs a plurality of comparison results. The image compensation unit is coupled to the image comparison unit and generates a compensation frame corresponding to the second eye frame according to the comparison results. Therefore, image sticking can be avoided.

### CROSS-REFERENCE TO RELATED APPLICATION

This application claims the priority benefit of Taiwan application serial no. 100133471, filed on Sep. 16, 2011. The entirety of the above-mentioned patent application is hereby incorporated by reference herein and made a part of this specification.

### BACKGROUND OF THE INVENTION

1. Field of the Invention

The present invention generally relates to a display apparatus and a data processing method thereof, and in particular, to a three-dimensional display apparatus and a data processing method thereof.

2. Description of Related Art

With the progress and development of science and technology, people pursue ever increasing enjoyment in material and spirit life. On the spiritual level, in the age that science and technology change with each passing day, people hope to realize wild imagination through three-dimensional displays and achieve the effect of personally experiencing the situation. Therefore, how to enable presentation of three-dimensional pictures or images by three-dimensional displays has become an urgent target of the three-dimensional display technology nowadays.

The three-dimensional display technology is approximately divided into a stereoscopic three-dimensional display technology in which a user needs to wear a pair of specially designed glasses for viewing and an auto-stereoscopic three-dimensional display technology of direct viewing with naked eyes. The stereoscopic three-dimensional display technology has been developed maturely and widely applied for special purposes such as military simulation or large-scale entertainment. However, due to undesirable convenience and comfort of the stereoscopic three-dimensional display technology, the auto-stereoscopic three-dimensional display technology has gradually developed into a new trend.

Generally speaking, the imaging manner of the auto-stereoscopic three-dimensional display technology is mainly time-multiplexed imaging. In the time-multiplexed imaging, a backlight source is used as a beam-splitting mechanism, and left and right eye frames are transferred to left and right eyes alternately and respectively through directional backlight sources, so as to achieve the three-dimensional display effect. Since the time-multiplexed imaging uses a time difference to generate a frame difference of left and right eyes, the frame rate is twice that of the conventional display manner. When the frame rate is twice, the pixel charging time is reduced to one half so that the pixel charging time may be insufficient, thereby causing an image sticking phenomenon in the conversion of left and right eye frames.

### SUMMARY OF THE INVENTION

The present invention is directed to a three-dimensional display apparatus and a data processing method thereof, capable of compensating for insufficient gray-scale writing in a parallax area of a left eye frame or right eye frame due to insufficient response time, thereby avoiding an image sticking phenomenon.

The present invention provides a display apparatus, which includes a data processing module, a display panel, a backlight module, a source driver, a gate driver, and a timing controller. The data processing module includes an image comparison unit and an image compensation unit. The image comparison unit receives a first eye frame and a second eye frame in order, compares a plurality of first gray-scale data of the first eye frame with a plurality of second gray-scale data of the second eye frame respectively, and outputs a plurality of comparison results. The image compensation unit is coupled to the image comparison unit and generates a compensation frame corresponding to the second eye frame according to the comparison results. The backlight module is used for providing a first directional surface light source or a second directional surface light source, so that an image displayed by the display panel is transferred to a left eye or a right eye. The source driver is coupled to the display panel. The gate driver is coupled to the display panel. The timing controller is coupled to the data processing module to receive the compensation frame, control the source driver to output a plurality of pixel voltages to the display panel according to the compensation frame, and control the gate driver to output a plurality of scanning signals to the display panel in order according to the compensation frame.

In an embodiment of the present invention, the backlight module includes a light guide plate, a first light source, and a second light source. The first light source forms the first directional surface light source through the light guide plate, so that the image displayed by the display panel is transferred to one of the left eye and the right eye. The second light source forms the second directional surface light source through the light guide plate, so that the image displayed by the display panel is transferred to the other one of the left eye and the right eye.

In an embodiment of the present invention, the display panel is a liquid crystal display panel.

In an embodiment of the present invention, the data processing module further includes a lookup table for storing a plurality of compensation data. The image compensation unit obtains the compensation data corresponding to the second gray-scale data from the lookup table according to gray-scale error values corresponding to the second gray-scale data, and generates the compensation frame according to the second gray-scale data and the corresponding compensation data.

In an embodiment of the present invention, the data processing module further includes a buffer coupled to the image comparison unit and storing the first gray-scale data and the second gray-scale data.

In an embodiment of the present invention, when an image format of the first eye frame and the second eye frame is a side-by-side format, the buffer is a linear buffer.

In an embodiment of the present invention, when an image format of the first eye frame and the second eye frame is one of a top-and-bottom format, a frame packing format, and a frame sequence format, the buffer is a frame buffer.

The present invention provides a data processing method, which includes the following steps. A first eye frame and a second eye frame are received in order. A plurality of first gray-scale data of the first eye frame is compared with a plurality of second gray-scale data of the second eye frame respectively to generate a plurality of comparison results. A compensation frame corresponding to the second eye frame is generated according to comparison results.

In an embodiment of the present invention, each of the comparison results includes a corresponding second gray-scale data and a gray-scale error value between the second gray-scale data and a corresponding first gray-scale data.

In an embodiment of the present invention, the step of generating the compensation frame corresponding to the second eye frame according to the comparison results includes: obtaining a plurality of compensation data corresponding to the second gray-scale data according to the gray-scale error values corresponding to the second gray-scale data, and generating the compensation frame according to the second gray-scale data and the corresponding compensation data.

In an embodiment of the present invention, the first eye frame is one of a left eye frame and a right eye frame, and the second eye frame is the other one of the left eye frame and the right eye frame.

Based on the above, in the embodiments of the present invention, the three-dimensional display apparatus, the data processing module, and the data processing method thereof compare the left eye frame with the right eye frame and generate the compensation frame corresponding to the left eye frame or the right eye frame according to comparison results, so as to avoid the image sticking phenomenon in the parallax area of the left eye frame or the right eye frame due to insufficient response time.

In order to make the aforementioned features and advantages of the present invention comprehensible, embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram of a display apparatus according to an embodiment of the present invention.

FIG. 2 is a flow chart of a data processing method according to an embodiment of the present invention.

FIG. 3 is a flow chart of a data processing method according to another embodiment of the present invention.

### DESCRIPTION OF THE EMBODIMENTS

Reference will now be made in detail to the present embodiments of the invention, examples of which are illustrated in the accompanying drawings. Wherever possible, the same reference numbers are used in the drawings and the description to refer to the same or like parts.

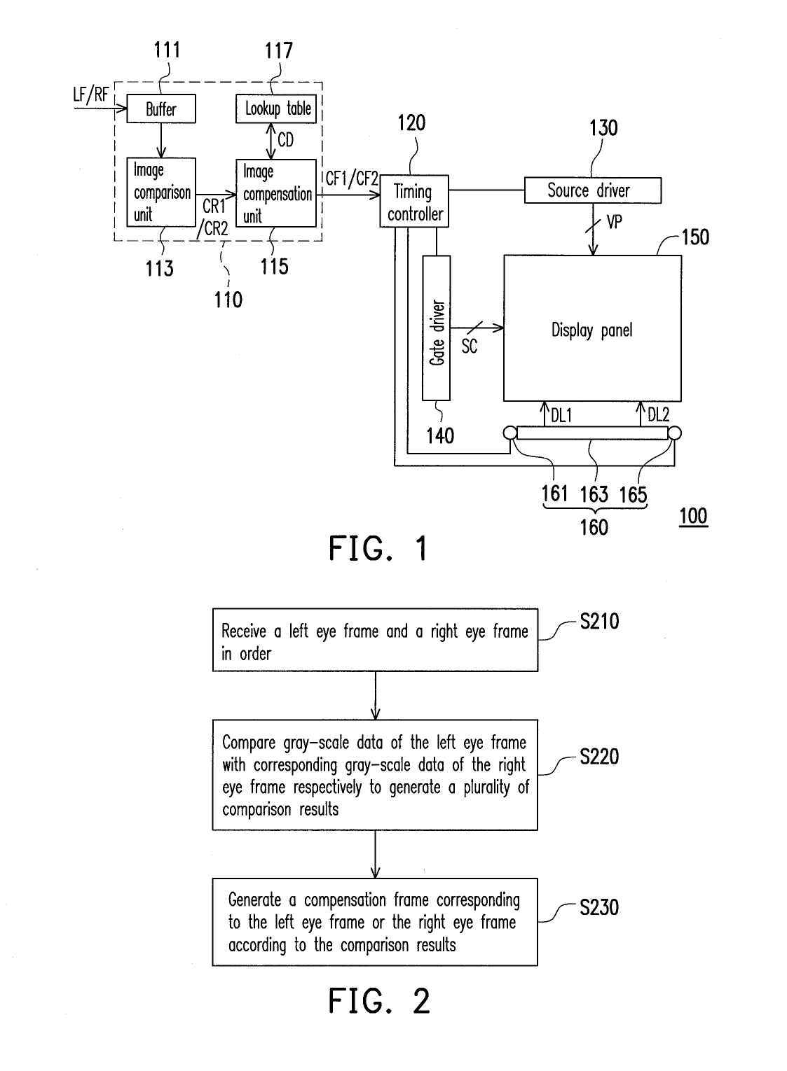

FIG. 1 is a schematic diagram of a display apparatus according to an embodiment of the present invention. Referring to FIG. 1, in this embodiment, the display apparatus 100 includes a data processing module 110, a timing controller 120, a source driver 130, a gate driver 140, a display panel 150, and a backlight module 160. The display panel 150 may be a liquid crystal display panel. The timing controller 120 is coupled to the data processing module 110 and is coupled to the source driver 130, the gate driver 140, and the backlight module 160. The source driver 130 is coupled to the display panel 150. The gate driver 140 is coupled to the display panel 150.

The data processing module 110 receives a left eye frame LF and a right eye frame RF in order, compares the left eye frame LF with the right eye frame RF, and generates a compensation frame CF1 corresponding to the left eye frame LF or a compensation frame CF2 corresponding to the right eye frame RF. For example, if the data processing module 110 receives the right eye frame RF (corresponding to the first eye frame) first, after comparing the left eye frame LF with the right eye frame RF, the data processing module 110 outputs the compensation frame CF1 corresponding to the left eye frame LF (corresponding to the second eye frame) according to comparison results. In addition, if the data processing module 110 receives the left eye frame LF (corresponding to the first eye frame) first, after comparing the left eye frame LF with the right eye frame RF, the data processing module 110 outputs the compensation frame CF2 corresponding to the right eye frame RF (corresponding to the second eye frame) according to comparison results. The compensation frames CF1 and CF2 are frames for an accelerated gray-scale writing process performed on a parallax area of the left eye frame LF and the right eye frame RF, so as to avoid an image sticking phenomenon caused by the fact that each of gray-scales of the parallax area does not reach a target gray-scale.

After receiving the compensation frame CF1 or CF2, the timing controller 120 controls the source driver 130 to output a plurality of pixel voltages VP to the display panel 150 according to the compensation frame CF1 or CF2, and controls the gate driver 140 to output a plurality of scanning signals SC to the display panel 150 in order according to the compensation frame CF1 or CF2. The display panel 150 receives the pixel voltages VP according to the scanning signals SC and displays a frame according to the received pixel voltages VP.

When the timing controller 120 receives the compensation frame CF1, since the compensation frame CF1 corresponds to the left eye frame LF, the timing controller 120 controls the backlight module 160 to generate a first directional surface light source DL1, so that the frame displayed by the display panel 150 is transferred to a left eye of a user. In addition, when the timing controller 120 receives the compensation frame CF2, since the compensation frame CF2 corresponds to the right eye frame RF, the timing controller 120 controls the backlight module 160 to generate a second directional surface light source DL2, so that the frame displayed by the display panel 150 is transferred to a right eye of the user. Thereby, when the display panel 150 alternately displays the left eye frame LF and the right eye frame RF, the first directional surface light source DL1 and the second directional surface light source DL2 are generated alternately, so that the left eye frame LF and the right eye frame RF can be alternately transferred to the left eye and the right eye of the user, thereby forming three-dimensional vision.

Furthermore, the data processing module 110 includes a buffer 111, an image comparison unit 113, an image compensation unit 115, and a lookup table 117. The lookup table 117 is used for storing a plurality of compensation data CD. The buffer 111 is coupled to the image comparison unit 113 and stores a plurality of gray-scale data of the left eye frame LF and a plurality of gray-scale data of the right eye frame RF. When an image format of the left eye frame LF and the right eye frame RF is a side-by-side format, since the buffer 111 can obtain the gray-scale data of the left eye frame LF and the right eye frame RF at the same time, the buffer 111 may be a linear buffer. When the image format of the left eye frame LF and the right eye frame RF is a top-and-bottom format, a frame packing format, a frame sequence format, or other image formats, since the buffer 111 cannot obtain the gray-scale data of the left eye frame LF and the right eye frame RF at the same time, the buffer 111 is set as a frame buffer.

The image comparison unit 113 receives the left eye frame LF and the right eye frame RF in order through the buffer 111, compares the left eye frame LF with the right eye frame RF, and outputs a plurality of comparison results (for example, CR1 or CR2). If the image comparison unit 113 receives the right eye frame RF (corresponding to the first eye frame) first, the image comparison unit 113 compares gray-scale data (corresponding to the first gray-scale data) of the right eye frame RF with corresponding gray-scale data (corresponding to the second gray-scale data) in the left eye frame LF respectively, thereby outputting a plurality of comparison results CR1 corresponding to the left eye frame LF. In an embodiment of the present invention, each comparison result CR1 may include a corresponding gray-scale data in the left eye frame LF and a gray-scale error value between the corresponding gray-scale data and a corresponding gray-scale data in the right eye frame RF. However, in other embodiments, each comparison result CR1 may include corresponding gray-scale data in the left eye frame LF and the right eye frame RF, which can be designed by persons of ordinary skill in the art by themselves.

If the image comparison unit 113 receives the left eye frame LF (corresponding to the first eye frame) first, the image comparison unit 113 compares gray-scale data (corresponding to the first gray-scale data) of the left eye frame LF with corresponding gray-scale data (corresponding to the second gray-scale data) in the right eye frame RF respectively, thereby outputting a plurality of comparison results CR2 corresponding to the right eye frame RF. In an embodiment of the present invention, each comparison result CR2 may include a corresponding gray-scale data in the right eye frame RF and a gray-scale error value between the corresponding gray-scale data and a corresponding gray-scale data in the left eye frame LF. However, in other embodiments, each comparison result CR2 may include corresponding gray-scale data in the left eye frame LF and the right eye frame RF, which can be designed by persons of ordinary skill in the art by themselves.

The image compensation unit 115 is coupled to the image comparison unit 113 and the lookup table 117, so as to obtain a compensation data CD corresponding to each gray-scale data of the left eye frame LF from the lookup table 117 according to the comparison results CR1, and generate the compensation frame CF1 corresponding to the left eye frame LF according to the gray-scale data of the left eye frame LF and the corresponding compensation data CD. Alternatively, the image compensation unit 115 obtains a compensation data CD corresponding to each gray-scale data of the right eye frame RF from the lookup table 117 according to the comparison results CR2, and generates the compensation frame CF2 corresponding to the right eye frame RF according to the gray-scale data of the right eye frame RF and the corresponding compensation data CD.

The backlight module 160 includes a first light source 161, a light guide plate 163, and a second light source 165. In this embodiment, when the display panel 150 displays the compensation frame CF1 corresponding to the left eye frame LF, the first light source 161 is turned on under the control of the timing controller 120, and forms the first directional surface light source DL1 through the light guide plate 163, so that the image displayed by the display panel 150 is transferred to the left eye of the user; and when the display panel 150 displays the compensation frame CF2 corresponding to the right eye frame RF, the second light source 165 is turned on under the control of the timing controller 120, and forms the second directional surface light source DL2 through the light guide plate 163, so that the image displayed by the display panel 150 is transferred to the right eye of the user. In other embodiments, due to different designs of the light guide plate 163, the first light source 161 may form the second directional surface light source DL2 through the light guide plate 163 so that the image displayed by the display panel 150 is transferred to the right eye of the user, and the second light source 165 may form the first directional surface light source DL1 through the light guide plate 163 so that the image displayed by the display panel 150 is transferred to the left eye of the user. The present invention is not thus limited.

FIG. 2 is a flow chart of a data processing method according to an embodiment of the present invention. Referring to FIG. 2, in this embodiment, a left eye frame and a right eye frame are received in order (Step S210). Then, gray-scale data of the left eye frame is compared with corresponding gray-scale data of the right eye frame respectively to generate a plurality of comparison results (Step S220). Finally, a compensation frame corresponding to the left eye frame or the right eye frame is generated according to the comparison results (Step S230). Reference can be made to the description of the display apparatus 100 for details of the above steps which will not be described herein again.

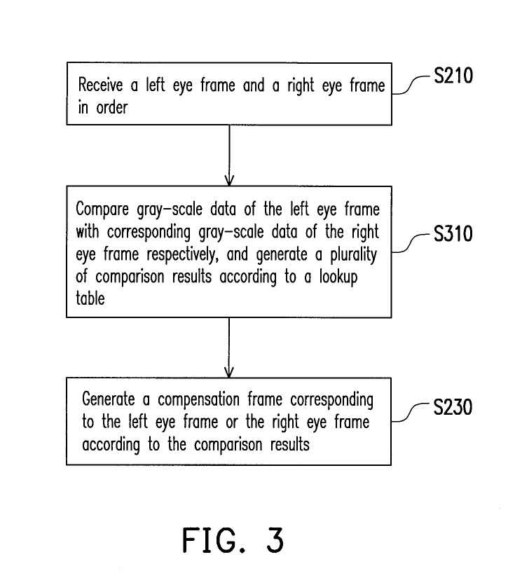

FIG. 3 is a flow chart of a data processing method according to another embodiment of the present invention. Referring to FIGS. 2 and 3, the difference lies in Step S310. In Step S310, gray-scale data of the left eye frame is compared with corresponding gray-scale data of the right eye frame respectively, and a plurality of comparison results is generated according to a lookup table.

In view of the above, in the embodiments of the present invention, the three-dimensional display apparatus, the data processing module, and the data processing method thereof compare the left eye frame with the right eye frame and generate the compensation frame corresponding to the left eye frame or the right eye frame according to comparison results, so as to avoid the image sticking phenomenon in the parallax area of the left eye frame or the right eye frame due to insufficient response time.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A three-dimensional display apparatus, comprising:
a data processing module, comprising:
an image comparison unit, for receiving a first eye frame and a second eye frame in order, comparing a plurality of first gray-scale data of the first eye frame with a plurality of second gray-scale data of the second eye frame respectively, and outputting a plurality of comparison results; and
an image compensation unit, coupled to the image comparison unit and generating a compensation frame corresponding to the second eye frame according to the comparison results;
a display panel;
a backlight module, for providing a first directional surface light source or a second directional surface light source, so that an image displayed by the display panel is transferred to a left eye or a right eye;
a source driver, coupled to the display panel;
a gate driver, coupled to the display panel; and
a timing controller, coupled to the data processing module to receive the compensation frame, controlling the source driver to output a plurality of pixel voltages to the display panel according to the compensation frame, and controlling the gate driver to output a plurality of scanning signals to the display panel in order according to the compensation frame.

2. The three-dimensional display apparatus according to claim 1, wherein each of the comparison results comprises a corresponding second gray-scale data and a gray-scale error value between the corresponding second gray-scale data and a corresponding first gray-scale data.

3. The three-dimensional display apparatus according to claim 2, wherein the data processing module further comprises a lookup table for storing a plurality of compensation data, the image compensation unit obtains the compensation data corresponding to the second gray-scale data from the lookup table according to the gray-scale error values corresponding to the second gray-scale data, and generates the compensation frame according to the second gray-scale data and the corresponding compensation data.

4. The three-dimensional display apparatus according to claim 1, wherein the data processing module further comprises:
a buffer, coupled to the image comparison unit and storing the first gray-scale data and the second gray-scale data.

5. The three-dimensional display apparatus according to claim 4, wherein when an image format of the first eye frame and the second eye frame is a side-by-side format, the buffer is a linear buffer.

6. The three-dimensional display apparatus according to claim 4, wherein when an image format of the first eye frame and the second eye frame is one of a top-and-bottom format, a frame packing format, and a frame sequence format, the buffer is a frame buffer.

7. The three-dimensional display apparatus according to claim 1, wherein the first eye frame is one of a left eye frame and a right eye frame, and the second eye frame is the other one of the left eye frame and the right eye frame.

8. The three-dimensional display apparatus according to claim 1, wherein the backlight module comprises:
a light guide plate;
a first light source, for forming the first directional surface light source through the light guide plate, so that the image displayed by the display panel is transferred to one of the left eye and the right eye; and
a second light source, for forming the second directional surface light source through the light guide plate, so that the image displayed by the display panel is transferred to the other one of the left eye and the right eye.

9. A data processing method, comprising:
receiving a first eye frame and a second eye frame in order;
comparing a plurality of first gray-scale data of the first eye frame with a plurality of second gray-scale data of the second eye frame respectively to generate a plurality of comparison results; and
generating a compensation frame corresponding to the second eye frame according to the comparison results.

10. The data processing method according to claim 9, wherein each of the comparison results comprises a corresponding second gray-scale data and a gray-scale error value between the corresponding second gray-scale data and a corresponding first gray-scale data.

11. The data processing method according to claim 10, wherein the step of generating the compensation frame corresponding to the second eye frame according to the comparison results further comprises:
obtaining a plurality of compensation data corresponding to the second gray-scale data according to the gray-scale error values corresponding to the second gray-scale data, and generating the compensation frame according to the second gray-scale data and the corresponding compensation data.

12. The data processing method according to claim 9, wherein the first eye frame is one of a left eye frame and a right eye frame, and the second eye frame is the other one of the left eye frame and the right eye frame.
